(19) United States
(12) Patent Application Publication
(10) Pub. No.: US 2008/0126152 A1
(43) Pub. Date: May 29, 2008

(54) Internet-based advertising and marketing management interactive system

(76) Inventors: Narciso Fernandez Villanueva, Barcelona (ES); Xavier Teixido Castillo, Palleja (ES); Ernesto Franco Bailo, Zaragoza (ES)

Correspondence Address: RATNERPRESTIA, P O BOX 980, VALLEY FORGE, PA, 19482-0980, US

(21) Appl. No.: 11/604,975

(22) Filed: Nov. 28, 2006

(51) Int. Cl. G06Q 10/00

(52) U.S. Cl. 705/7; 705/14

(57) ABSTRACT

An internet-based advertising and marketing management interactive system, comprising a first web site including an interactive visual interface based on a software program, making available on a screen a plurality of adjacent boxes displayed in a prearranged order, including images and/or texts with synthesized information about a brand or service of an advertiser, creating a center of attention to said brand or service, said plurality of adjacent boxes composing as a whole an advertising collage. Each of said boxes linked to an advertiser URL site, prepared to be activated once a click on a selected box is made by a user and means to alter said prearranged order of said boxes of said advertising collage at the time the user returns to said first website having previously exited it by clicking on a box, said means to alter providing a noticeable change in said boxes and a dynamic scenario.

### FIELD OF THE INVENTION

The present invention relates to on-line advertising systems intended for brands, local retailers and shops on line providing an effective tool to increase competitiveness. In particular it refers to a software system implemented in the Internet including an interactive visual interface displaying on a screen advertising information that is presented to a user prompting the user to get in touch with a site providing a wide information about the advertised product or service while on returning on the screen a noticeable change on the presentation of the information occurs so that the system concentrates and integrates several information and links to a related wide information in a single computer-based dynamic scenario allowing an advertiser to display theirs adds where they wish.

The system also provides control and measure tools to manage said interface.

The description of this invention contains material which has been protected by copyright. The proprietors of said copyright have no objection to the reproduction of the description of this document of application of a patent as it will be published or as a final version at the Patent Office by third parties, but they reserve any right on the copyright in other aspect arising from said document.

### BACKGROUND OF THE INVENTION

U.S. Pat. No. 5,918,214 refers to a system and method for finding product and service related information on the internet and discloses an Internet Server which store information pertaining to an Universal Product previously assigned to each product and Uniform resource locator that point to the location of one or more information resources on the Internet allowing requests made by a client system.

U.S. Pat. No. 6,753,887 discloses a method of causing brand indicia of a selected network access provider to be presented through a user interface associated with client software, the software being configurable to be used in conjunction with one of a plurality of network access providers.

U.S. Pat. No. 7,092,896 discloses an interface for merchandise promotion optimization where a computer-based scenario/results processor is used to present a sequence of data template to a user including supplier offer configuration template, whereby the user specifies an optimization scenario.

U.S. 2005/0010475 describes an Internet-based brand marketing communication system for enabling a vendor and its agents to carryout product-related marketing communication functions along the demand side of a retail chain.

U.S. 2005/0144072 refers to an online brand information management and marketing communication system including a first Web-based subsystem for brand management and a second Web-based subsystem for remotely program advertising display of a virtual kiosk with one or more advertising sots in a selected order.

### SUMMARY OF THE INVENTION

The present invention is an internet-based advertising and marketing management interactive system stored on a computer readable medium that based on a special conception different to the previous detailed solutions, concentrates and integrates information and links to a related wide information in a single computer-based dynamic scenario including a plurality of differentiated clickable areas or boxes providing a synthesized information about a product or service in an attractive way that prompts a person while clicking on it to accede to a wide related information.

The system according to this invention comprises in general:

a first web site;

an interactive visual interface based on a software program, at said first web site, prepared to make available on a screen a plurality of adjacent boxes, differentiated among them, that are displayed in a prearranged order, each of said boxes including images and/or texts that contain a very synthesized information about or a pointer to a brand or a service of advertisers by providing a powerful center of attention to said brand or service, prompting a person or user to go through, said plurality of adjacent boxes that compose as a whole an eye-catching advertising collage or multi image-text wall acting as a virtual show case;

a link of each of said boxes to an advertiser URL site, prepared to be activated once a click on a selected box of said plurality of boxes is made by a user, having gain access to said first web side; and

means to alter said prearranged order of said boxes of said virtual show case at the time the user returns to said first website having previously exited it by clicking on a box, said means to alter providing a noticeable change in said boxes, that can be of different forms, such as a change of position of said boxes, an introduction of one (or more) new box/es in said plurality of boxes and corresponding removal of a previous box (or boxes), a change of size, color in at least a part of each box, a different perimeter delimitation, distance among boxes or a grouping of at least two boxes into a big box fully integrated with the rest of boxes.

According to the invention said noticeable change providing a dynamic behavior is conducted through a random process or through a directed model where location of a new box or another change is predetermined. Said directed model is performed by under control of a dedicated server.

The images and/or texts that compose the information on each box include in general a trademark or trade name of an advertiser while usually interspersed with some graphic and/or picture that makes the multi-spot attractive and evocative

Moreover each of said advertising collage or multi image-text, i.e. show cases include only messages or information relevant to the features of a particular audience reaching an internet site directly or trough another website (other websites can have passageways to some specific show cases).

The system is based in a non comparative model among products and services, instead of such a proposal the system proposes a plurality of independent stands or corners that allow to show different advertising messages in a dynamic (mentioned changes in the boxes) re-directing the users of the system towards the URLs of the traders or dealers. Alternatively any trade can show star products or services in a showcase that capture and fix the attention of potential purchaser leading towards a URL where wide information is given, in particular detailed information on the product and how to obtain it.

A product or service when compatible can appear in two or more different stands increasing in this way the presence in the market and the chances to capture audience.

A whole commercial potential of the invention is obtained when the number of clicks on a given box are counted and accumulated under control of referred dedicated server so that the advertisers can be informed about these figures and debited only taking into account said number of access to the respective URLs, termed impressions, i.e. each time a user really has acceded to their site. The identification of users (by any of know tracing techniques) having shown a particular interest on a determined site via box or boxes of access can benefit of promotions.

Therefore the system allows a trader or dealer (either a retailer or a wholesaler) wishing to operate in the Internet media field to improve their advertising, promotion or sale campaigns with the lowest possible cost, as said cost is only based on the results (for example number of user's clicks obtained).

Using the referred interface of the system a trader or dealer can find the most efficient way to:
advertise-inform in a regular manner to people living around;
open their own on-line shop with an easy and economic maintenance cost;
perform promotions to users of the system that really have shown a particular interest in a product or service, tracing them;
expand the knowledge scope on a brand or trade name products/services and therefore the business range outside a conventional area of influence; and
increase the recognition of the trader's brand or trade name among users.
update the features of the box acting as a door entrance to their Website;

An additional object of the invention offers an internet-based advertising and marketing management interactive system having the features above described and wherein said first website is linked to a second website of more general or wide content so that said first website can be acceded by a link included in said second website adding to it an advertising value.

In an alternative embodiment said first website is linked to a second website being a non commercial web site so that said first website can be acceded by a link included in said second website adding to it an advertising value.

Therefore the system as per the invention allows obtaining a meeting-point for advertisers, consumers and users which is at the same time global and local and which operates adding advertising information and concentrating audiences and reaching the following general aims:
be a browser—ruler suitable to find at any moment news, promotions and opportunities of brands and shops and informing about;
be and advertising channel attractive for large coverage Website editors, that can include it as a useful service for their clients;
provide a place where both local and remote (on-line accessible) products and services come together;
be cost favorable taking into account the investment;
provide efficient solutions (simple and economic) to allow any advertiser independently of the kind of activity to optimize advertise, promotion and sale actions both on-line and offline.

To implement the system an adserver with calculated (number of showcases under control) capability will be used providing at any time on-line control of any of the actions occurring on the screen of the interface.

These and other advantages of the invention will be apparent to those of ordinary skill in the art by reference to the following detailed description and the accompanying drawings.

### BRIEF DESCRIPTION OF THE DRAWINGS

In the drawings:

FIG. 1 is a diagram showing the system of the invention operating as a focal point intended for capturing general audiences who are able to explore the ads which best correspond to their interest, desires and/or needs; this FIG. illustrating the internet-based interactive system of the invention (“Shoppresa” is a Trademark) and the relation among the components and/or actors in a dynamic scenario;

FIG. 2 shows an example of a grid of empty boxes that provide a basis for the implementation of the system as per the invention;

FIG. 3 shows a typical example of an advertising collage wall that a user can reach on a screen and that operates as interactive interface as per the above description;

FIGS. 4 and 5 show the same advertising collage wall at two different temporal moments showing that some of the boxes have been grouped to present another advertising item at a big size;

FIG. 6 illustrates another embodiment of the advertising collage wall that operates as an on-line shop;

FIGS. 7 and 8 show another alternative embodiment for an advertising collage wall that operates as advertising for a single customer or client; in this case the two Figs. allow to see how several boxes experiment during the time a change several of them being grouped and the content of one or more boxes suffering a partial alteration.

FIG. 9 corresponds to an embodiment for an advertising collage wall in which several of the boxes are direct doors to electronic newspapers.

FIG. 10 shows an embodiment of the system wherein said boxes show ads of a same firm with single or different products.

FIGS. 11 to 13 show an embodiment where an item of the boxes turns into a very big size occupying the entire screen and with some movable parts.

The system can be implemented in a plurality of additional and varied embodiments including mixing some of the proposals but the examples in the cited Figs. sufficiently allow perceiving the potential of the system as an advertising tool in the e-market.

### DETAILED DESCRIPTION OF SOME OF THE EMBODIMENTS

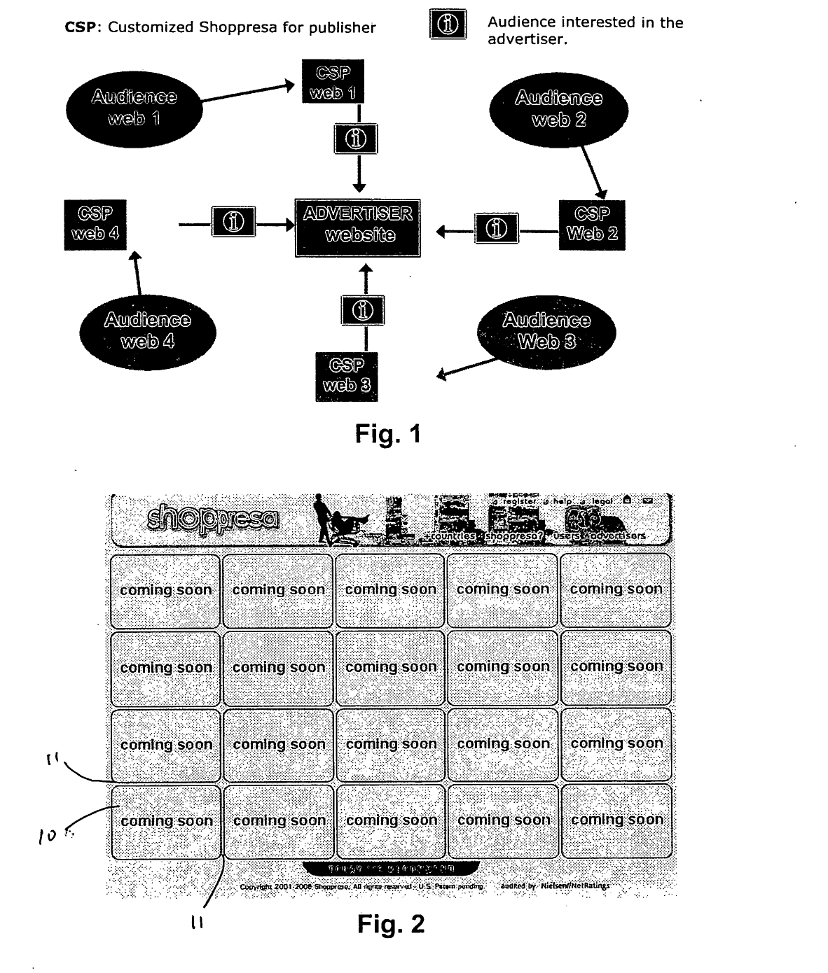

In FIG. 1 the internet-based interactive system of this invention that is especially suitable for advertising and marketing management activities is termed as advertiser website, placed in the center and surrounded by customized webs from 1 to 4. Audience interested in the advertiser website represented by the small boxes including and “i” within a circle reaches the customized webs from a particular previous website from 1 to 4.

FIG. 2 shows a preferred example of a basic visual interface construction comprising a plurality of adjacent boxes 10 organized in a grid of rows and columns that are displayed in a prearranged order. The boxes are separated among them with a small distance 11 while this parameter as well as the size and number of rows and column can vary. In the given example the grid includes 5 columns and 4 rows. In a particular embodiment it has been foreseen to chain together a plurality of visual interfaces related to a first one, displayable as a tree directory.

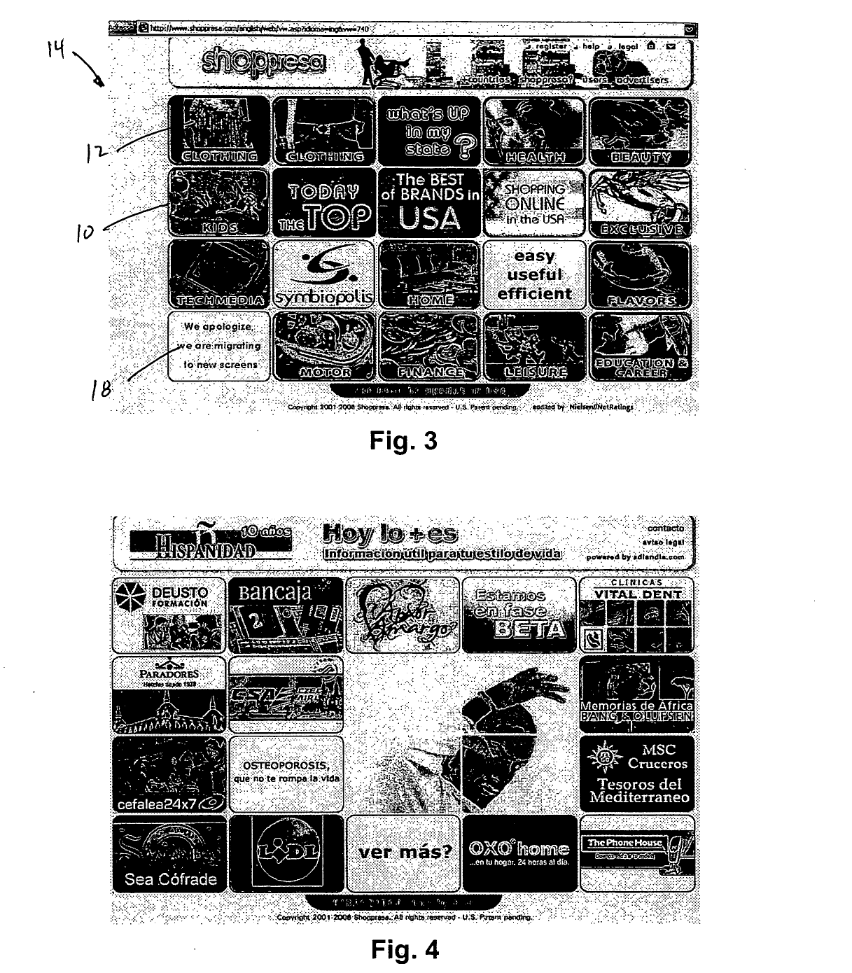

In FIG. 3 all the properties of the visual interactive interface of this invention can be appreciated i.e. this interactive interface comprises:
a first website;
a plurality of adjacent boxes 10 adjacent boxes that are displayed in a prearranged order, organized in a grid of rows and columns, each of said boxes including images 12 and/or texts 13 that enclose a synthesized information about or a pointer to a brand or a service of advertisers, creating a very powerful center of attention to said brand or service;
a link of each of said boxes to an advertiser URL site, prepared to be activated once a click on a selected box of said plurality of boxes is made by a user, having gain access to said first web side; and

means to alter said prearranged order of said boxes of said virtual show case at the time the user returns to said first website having previously exited it by clicking on a box, said means to alter providing a noticeable change in said boxes,

Therefore the plurality of adjacent boxes, that are differentiated among them, compose as a whole an advertising collage 14 or multi image-text wall acting as a virtual show case, and this interactive system concentrates and integrates several information and links to related wide information in a dynamic scenario.

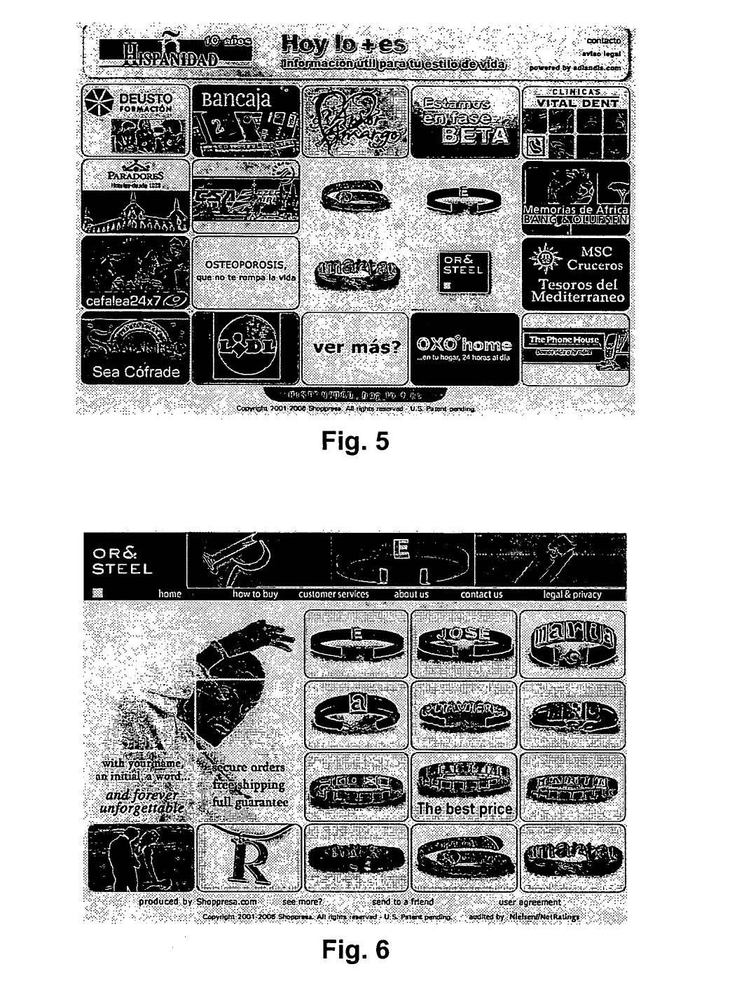

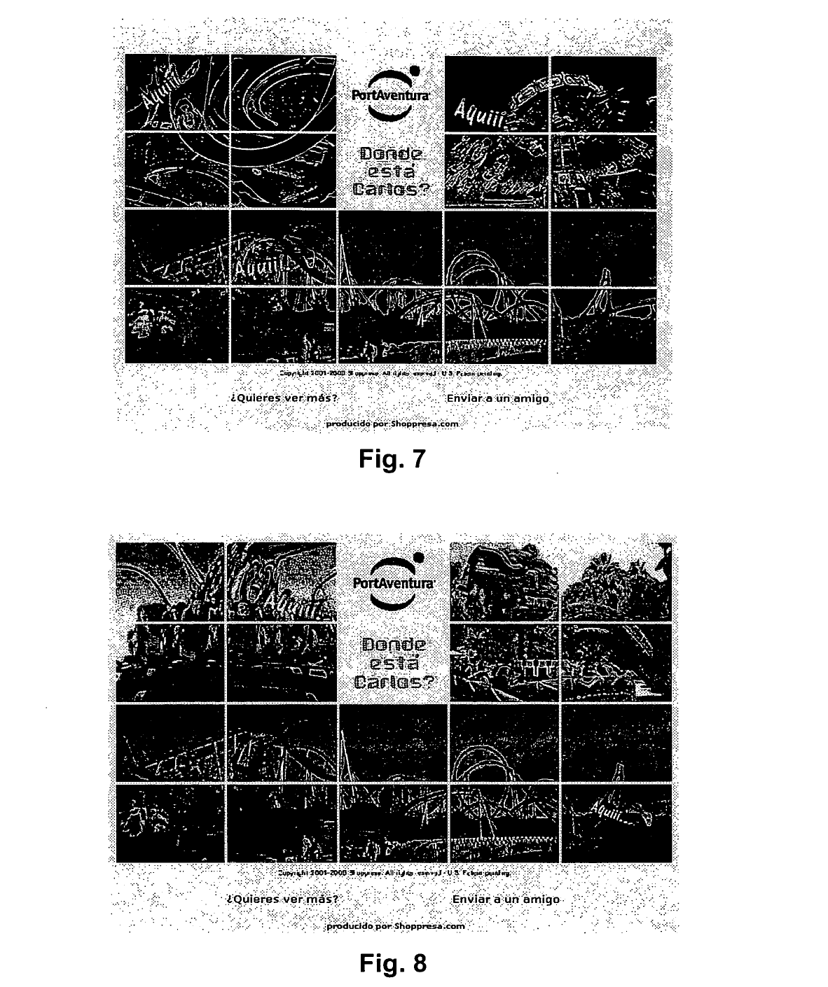

The referred noticeable change is a change of position of said boxes, an introduction of at least one new box in said plurality of boxes and removal of a previous box, a change of size, color in at least a part of each box, different perimeter delimitation or a grouping of at least two boxes. FIGS. 4 and 5 allow to understand the operative of the last alternative wherein two or more of said adjacent boxes (FIG. 4) can change to give birth to a single box (FIG. 5) under the control of the program to show an image of a bigger size static or dynamic, mixed among the rest of the images of said plurality of boxes.

The boxes 10 can be displayed in an alternative embodiment in variable grid size and they include in general information about or directly present at least a brand of an advertiser.

According to the invention the noticeable change is conducted through a random process or in the alternative through a directed model where in the case of location of a new box said location is predetermined.

The images 12 or images 12 and texts 13 of said plurality of boxes 10 are of any kind of format and size, and they can be static or dynamic in order to provide in said last case an interactive link.

In a first embodiment in a single show case boxes 10 of different types are combined.

In the example of FIG. 3, which shows a very common implementation of the proposed system images 12 and/or texts 13 of different firms or origins related to diverse brands or trade names are combined in a single virtual show case.

The differentiation among the boxes can be obtained by any of the following means:
a color;
a distance among the boxes;
a size;
a perimeter line (having diverse thickness and development) delimiting any of the boxes

The interactive visual interface described is open:
a) once a user accedes the domain linked to this interface;
b) once a user make a click of another website;
c) automatically under the browser of the website to which it is linked opening a new browser where the interface is displayed.
d) automatically as a pop under;
e) as a previous page while the main site where is linked is displaying
f) as an inter-page within another web site.

In a general way of operating the interactive visual interface is also reload automatically under a controlled frequency presenting each time a different grid of images and/or texts.

This interactive visual interface can be used as a show case of a virtual commerce in which case the boxes are linked to a product page site.

As previously indicated the number of clicks on a given box are counted and accumulated under control of a dedicated server, for example and adserver, and from the captured data the advertisers are immediately informed about the counted clicks. In addition the advertisers are debited taking into account said number of access to their respective URLS.

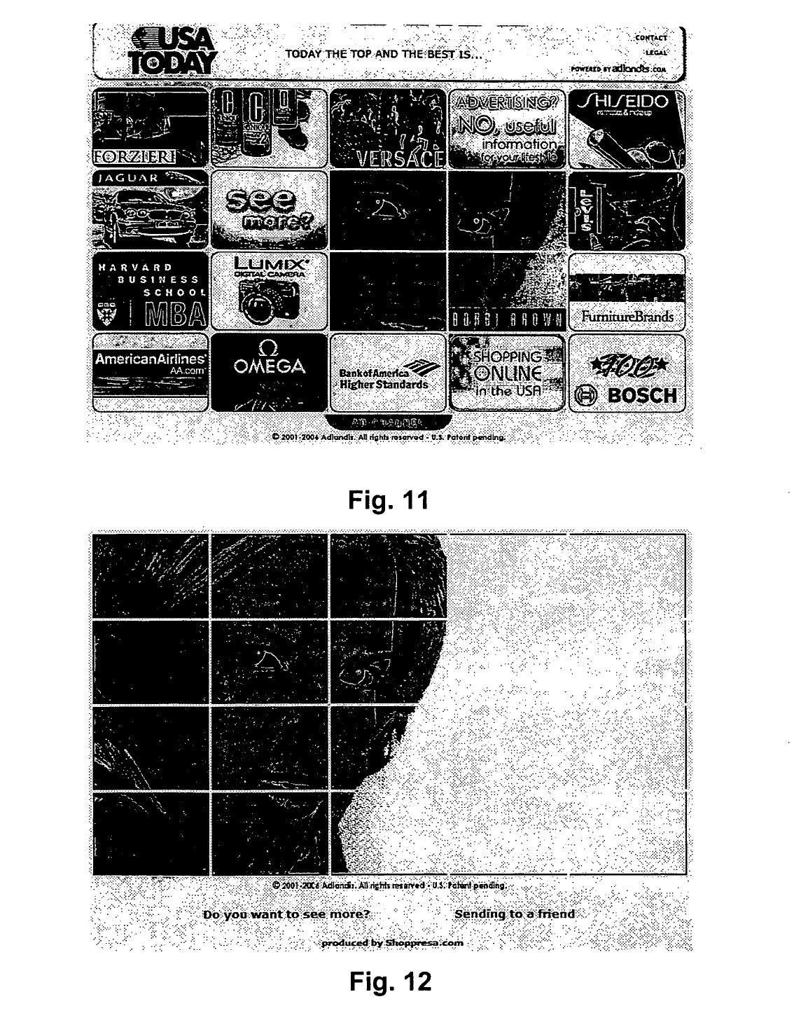

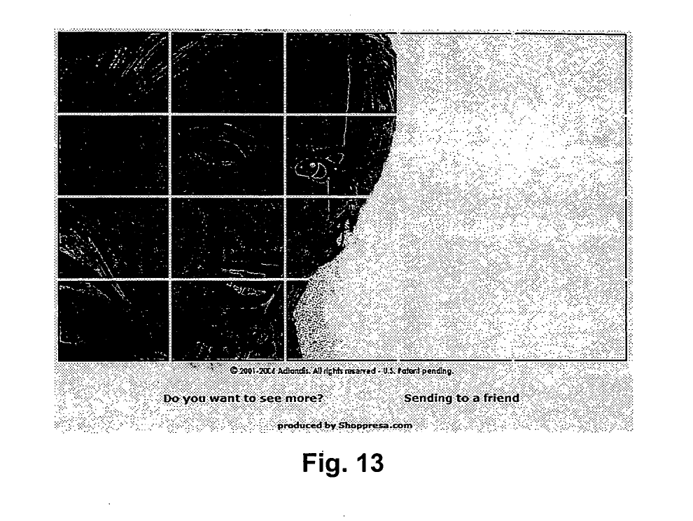

FIG. 11 illustrates an embodiment of the system, wherein boxes 10 show ads of a same firm with a single or different product.

According to this invention the referred first website providing the visual interface on a screen is linked to a second website of more general or wide content so that said first website can be acceded by a link included in said second website adding to it an advertising value.

In an alternative embodiment the first website is linked to a second website being a non commercial web site so that the first website can be acceded by a link included in the second website adding to it an advertising value.

Still in another embodiment said interactive interface can constitute by itself a website or a page available from any site.

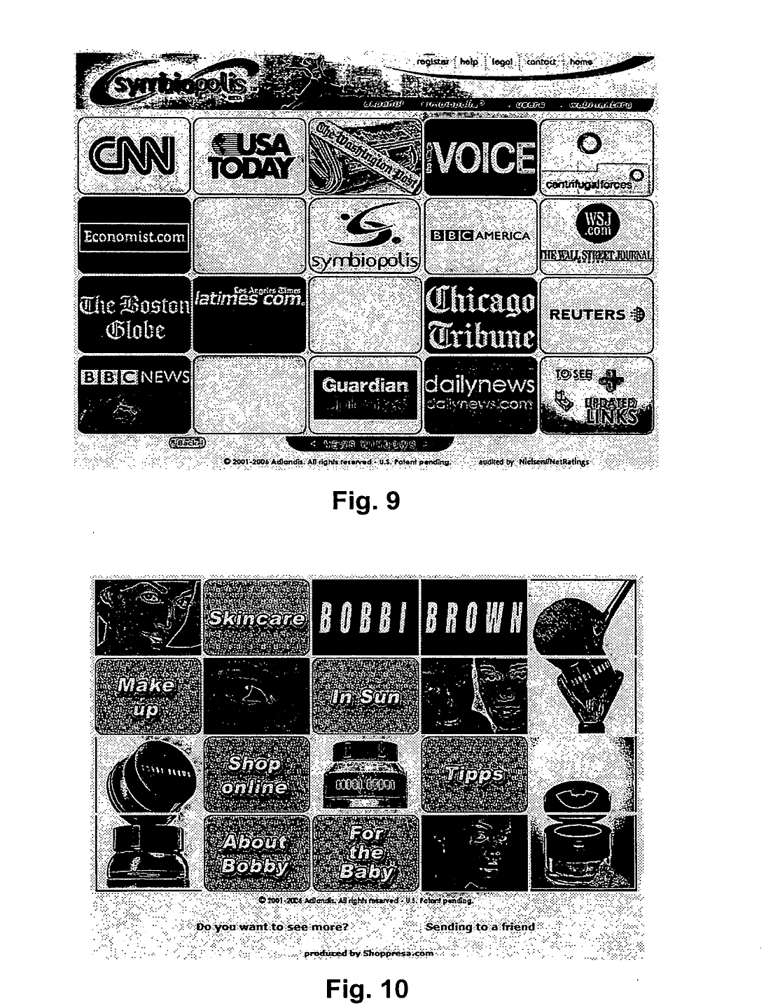

In most of the embodiments the advertising format of the boxes10 used for a particular advertiser share common features so that they provide a personalized add format for a single advertiser. FIGS. 8 and 9 show this Example.

The system according to this invention can be distributed globally through other sites based in any country, providing a facility for advertisers to display their images and/or text messages at their convenience.

Those skilled in the art should appreciate that they can readily use the disclosed conception and specific embodiments as a basis for designing or modifying other structures for carrying out the same or alternative purposes (marketing campaigns based on coupon promotion) of the present invention and that various changes or substitutions can be made herein without departing from the spirit and scope of the invention as defined by the appended claims.

1. An internet-based advertising and marketing management interactive system stored on a computer readable medium, comprising:
at least a first web site;
an interactive visual interface based on a software program, at said first web site, making available on a screen a plurality of adjacent boxes that are displayed in a prearranged order, each of said boxes including images and/or texts that enclose a synthesized information about or a pointer to a brand or a service of advertisers, creating a center of attention to said brand or service, said plurality of adjacent boxes composing as a whole an advertising collage or multi image-text wall acting as a virtual show case;
a link of each of said boxes to an advertiser URL site, prepared to be activated once a click on a selected box of said plurality of boxes is made by a user, having gain access to said first web side; and
means to alter said prearranged order of said boxes of said virtual show case at least at the time the user returns to said first website having previously exited it by clicking on a box, said means to alter providing a noticeable change in said boxes,
wherein the system concentrates and integrates several information and links to related wide information in a dynamic scenario.

2. The system according to claim 1, wherein said noticeable change is either a change of position of said boxes, an introduction of at least one new box in said plurality of boxes and removal of a previous box, a change of size, color in at least a part of each box, a different perimeter delimitation or a grouping of at least two boxes.

3. The system according to claim 2, wherein said noticeable change is conducted through a random process.

4. The system according to claim 2, wherein said noticeable change is conducted through a directed model where location of a new box is predetermined.

5. The system according to claim 1, wherein said adjacent boxes are differentiated among them.

6. The system according to claim 5, wherein said differentiation among the boxes is obtained by any of the following means:
a color;
a distance among the boxes;
a size;
a perimeter line delimiting any of the boxes

7. The system according to claim 1 wherein the number of clicks on a box of said plurality of adjacent boxes are counted and accumulated under control of a dedicated server or an adserver and in that the advertisers are informed about the number of access to said first website or counted clicks and debited taking into account said number of access to their respective URLs.

8. The system according to claim 1, wherein said images or images and texts of said plurality of boxes are of any kind of format and size, and they are static.

9. The system according to claim 1, wherein said images and/or texts of said plurality of boxes are dynamic in order to provide an interactive link.

10. The system according to claim 8, wherein in a single show case boxes of different types are combined.

11. The system according to claim 1, wherein said boxes show images and/or texts of different firms or origins providing brands or trade names.

12. The system according to claim 1, wherein said boxes show ads of a same firm with a single or different products.

13. The system according to claim 1, wherein said at least first website is linked to a second website of more general or wide content so that said first website can be acceded by a link included in said second website adding to it an advertising value.

14. The system according to claim 1, wherein said at least first website is linked to a second website being a non commercial web site so that said first website can be acceded by a link included in said second website adding to it an advertising value.

15. The system according to claim 1, wherein said interactive interface can constitute by itself a website (or a page available from any site.

16. The system according to claim 1, wherein said adjacent boxes are organized in a grid of rows and columns.

17. The system according to claim 16, wherein said grid includes 8 or less columns and 8 or less rows.

18. The system according to claim 16, wherein said grid include 5 columns and 4 or more rows.

19. The system according to claim 16, wherein it comprises a plurality of grid interfaces related to a first one, displayable as a tree directory.

20. The system according to claim 16, wherein two or more of said adjacent boxes can change to give birth to a single box under the control of the program to show an image of a bigger size static or dynamic, mixed among the rest of the images of said plurality of boxes.

21. The system according to claim 1 wherein said interface is used as a show case of a virtual commerce in which case the boxes are linked to a product page site.

22. The system according to claim 8, wherein the advertising format of the boxes used for a particular advertiser share common features so that they provide a personalized add format for a single advertiser.

23. The system according to claim 1, characterized in that said interface is open:
g) once a user accedes the domain linked to this interface;
h) once a user make a click of another website;
i) automatically under the browser of the website to which it is linked opening a new browser where the interface is displayed.
j) as a pop under;
k) as a previous page while the main site where is linked is displaying
l) as an inter-page within another web site.

24. The system according to claim 1 wherein said interactive interface is also reload automatically under a controlled frequency presenting each time a different grid of images and/or texts.

25. The system according to claim 1, wherein each of said boxes include information about or directly present at least a brand of an advertiser.

26. The system according to claim 1, wherein it is distributed globally through other sites based in any country, providing a facility for advertisers to display their images and/or text messages at their convenience.

27. The system according to claim 9, wherein in a single show case boxes of different types are combined.

28. The system according to claim 9, wherein the advertising format of the boxes used for a particular advertiser share common features so that they provide a personalized add format for a single advertiser.

29. The system according to claim 1, wherein the computer readable medium is at least one of a solid state storage device, a magnetic storage device, and/or an optical storage device.
